(19) United States
(12) Patent Application Publication
(10) Pub. No.: US 2003/0096893 A1
(43) Pub. Date: May 22, 2003

(54) Oxidatively drying coating composition

(76) Inventors: Ritse Eltjo Boomgaard, Oegstgeest (NL); Herbert Schier, Holtland (DE); Eric Jacob Jan Kirchner, Leiden (NL); Robert Paul Klaasen, Amsterdam (NL); Frantisek Hartl, Almere (NL); Ronald Petrus Catharina van der Leeuw, Leiden (NL); Frank Johannes Alfred Dirk Bakkeren, Sassenheim (NL)

Correspondence Address: LAINIE E. PARKER, AKZO NOBEL INC., 7 Livingstone Avenue, Dobbs Ferry, NY, 10522-3408, US

(21) Appl. No.: 10/252,810

(22) Filed: Sep. 23, 2002

Related U.S. Application Data
(60) Provisional application No. 60/337,777, filed on Dec. 3, 2001.

(30) Foreign Application Priority Data
Sep. 28, 2001 (EP) 01203689.3

(51) Int. Cl. C08K 5/17; C08K 5/04

(52) U.S. Cl. 524/236; 524/394

(57) ABSTRACT

A coating composition comprising an oxidatively drying coating binder and a chelate comprising at least one group according to the following formula I:

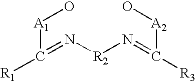

forms a complex with a metal ion. A1 and A2 are both an aromatic residue, R1 and R3 are covalently bonded groups, and R2 is a divalent organic radical, wherein at least one solubilizing group is covalently bonded to the chelating compound. The solubilizing group is a non-polar group, preferably an aliphatic group having at least four carbon atoms, covalently bonded to A1 and/or A2. The metal ion is a divalent ion of a metal selected from the group of manganese, cobalt, copper, lead, zirconium, iron, lanthanium, cerium, vanadium, and calcium or a trivalent ion of a metal selected from the group of manganese, cobalt, lead, zirconium, iron, lanthanium, cerium, and vanadium, combined with a monovalent counterion.

This application claims priority of U.S. Provisional Application 60/337,777, filed Dec. 3, 2001.

### FIELD OF THE INVENTION

The present invention relates to a coating composition comprising an oxidatively drying coating binder and a chelating ligand according to the following formula I:

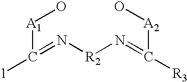

forming a complex with a metal ion. A1 and A2 both are an aromatic residue. R1 and R3 are covalently bonded groups, for example hydrogen or an organic group. R2 is a divalent organic radical. Together with a suitable metal ion, the chelating ligand can form a metal complex having a catalytic effect on the curing of oxidatively drying polymers, in particular alkyd resins.

### BACKGROUND OF THE INVENTION

U.S. Pat. No.3,956,211 discloses an alkyd based composition with a compound similar to that of formula I including a divalent lead ion, a zirconium ion or a divalent ion of a metal of the first transition group, except for nickel. In this disclosure, R1 and R3 are hydrogen. The effectiveness of these siccatives proved to be moderate.

EP-A 1 114 836 discloses the use of compounds of formula I for the preparation of resins for urushi lacquers by oxidative polymerization of phenol-functional vegetable oils.

### SUMMARY OF THE INVENTION

The object of the invention is to improve the effectiveness of such chelating compounds.

The object of the invention is achieved by a coating composition according to the opening paragraph, wherein at least one solubilizing group is covalently bonded to the compound of formula I. It has been found that by improving the solubility of the compound, its effectiveness is increased substantially as well. Although it was to be expected that the presence of a solubilizing group, typically having an electron-inductive effect, would disturb the chelate function, it has been found that the catalyzing effect is better than with prior art siccatives.

### DETAILED DESCRIPTION OF THE INVENTION

When the inventive coating composition is used for compositions based on organic solvents, non-polar solubilizing groups are preferred. Representative examples of such non-polar groups are aliphatic groups having at least four carbon atoms. Optionally, these groups may be branched alkyl groups, such as tert. butyl groups. The solubilizing group can be covalently bonded to A1 and/or A2 and/or can be R1, R2 and/or R3. Preferably, both aromatic groups are provided with a solubilizing group.

When used for water borne compositions, polyalkylene oxide groups, such as polyethylene oxide or polypropylene oxide groups, are preferred.

A1 and A2 are aromatic groups, for example derived from benzene or naphthalene, optionally substituted, e.g., with electron donating groups. Alternatively, A1 and/or A2 may be a heterocyclic aromatic group, derived from, for example, pyridine or quinoline. R2 can be a linear, branched, or cyclic organic compound, such as ethylene, propylene, isopropylene, butylene, tert. butylene, pentylene, hexylene, a cycloalkylene, such as cyclohexylene, cycloheptylene, etc.

Optionally, A1, A2, R1, R2 and/or R3 can be covalently bonded to a polymer, or to one or more further groups according to formula I. A preferred embodiment is a poly-chelate having at least two groups according to formula I mutually linked by R1 and/or R3.

The metal ion can be a divalent ion of a metal which may for example be selected from the group of manganese, cobalt, copper, lead, zirconium, iron, lanthanium, cerium, vanadium, and calcium.

Alternatively, the metal ion can be a trivalent or higher valency ion of a metal combined with one or more counterions. Suitable metals are for example manganese, cobalt, lead, zirconium, iron, lanthanium, and vanadium. Examples of suitable counterions are halogen ions, octoate, benzoxy or mixtures thereof.

The coating composition can be solvent borne, water borne or solvent-free. If the composition is solvent borne, non-aromatic solvents are preferred. A suitable solvent is for example Shellsol® D40, available from Shell.

Typical oxidatively drying binders are alkyd resins. At least a part of the alkyd resin is oxidatively drying as a result of the incorporation of a large number of unsaturated, aliphatic compounds, at least a portion of which is polyunsaturated. The unsaturated aliphatic compounds preferably are unsaturated fatty acids, more particularly polyunsaturated fatty acids. Examples of fatty acids comprising one equivalent of unsaturated CC bonds are myristoleic acid, palmitoleic acid, oleic acid, gadoleic acid, erucic acid, and ricinoleic acid and mixtures thereof. Examples of fatty acids comprising two or more equivalents of unsaturated CC bonds include linoleic fatty acid, linolenic fatty acid, elaeostearic fatty acid, licanic fatty acid, arachidonic fatty acid, clupanodonic fatty acid, nisinic fatty acid, and mixtures thereof. Fatty acids containing conjugated double bonds, such as dehydrated castor oil fatty acid, wood oil fatty acid and/or calendula oil fatty acid, can be used as well. Fatty acids derived from soya oil are especially suitable.

Examples of suitable divalent polyol compounds are ethylene glycol, 1,3-propane diol, 1,6-hexane diol, 1,12-dodecane diol, 3-methyl-1,5-pentane diol, 2,2,4-trimethyl-1,6-hexane diol, 2,2-dimethyl-1,3-propane diol, and 2-methyl-2-cyclohexyl-1,3-propane diol. Examples of suitable triols are glycerol, trimethylol ethane, and trimethylol propane. Suitable polyols having more than 3 hydroxyl groups are pentaerythritol, sorbitol, and etherification products of the compounds in question, such as ditrimethylol propane and di-, tri-, and tetrapentaerythritol. Preferably, use is made of compounds having 3-12 carbon atoms, e.g., glycerol, pentaerythritol and/or dipentaerythritol.

Alternatively or additionally, polycarboxylic acids can be used as building blocks for the oxidatively drying polyunsaturated condensation products. Examples of suitable polycarboxylic acids include phthalic acid, citric acid, fumaric acid, mesaconic acid, maleic acid, citraconic acid, isophthalic acid, terephthalic acid, 5-tert. butyl isophthalic acid, trimellitic acid, pyromellitic acid, succinic acid, adipic acid, 2,2,4-trimethyl adipic acid, azelaic acid, sebacic acid, dimerized fatty acids, cyclopentane-1,2-dicarboxylic acid, cyclohexane-1,2-dicarboxylic acid, 4-methylcyclohexane-1,2-dicarboxylic acid, tetrahydrophthalic acid, endomethylene-cyclohexane-1,2-dicarboxylic acid, butane-1,2,3,4-tetracarboxylic acid, endoisopropylidene-cyclohexane-1,2-dicarboxylic acid, cyclohexane-1,2,4,5-tetracarboxylic acid, and butane-1,2,3,4-tetracarboxylic acid. If so desired, the carboxylic acids in question may be used as anhydrides or in the form of an ester, e.g., an ester of an alcohol having 1-4 carbon atoms.

Optionally, the oxidatively drying polyunsaturated condensation product may comprise other building blocks, which may for example be derived from monocarboxylic acids such as pivalic acid, 2-ethylhexanoic acid, lauric acid, palmitic acid, stearic acid, 4-tert. butyl-benzoic acid, cyclopentane carboxylic acid, naphthenic acid, cyclohexane carboxylic acid, 2,4-dimethyl benzoic acid, 2-methyl benzoic acid, benzoic acid, 2,2-dimethylol propionic acid, tetrahydrobenzoic acid, and hydrogenated or non-hydrogenated abietic acid or its isomer. If so desired, the monocarboxylic acids in question may be used wholly or in part as triglyceride, e.g., as vegetable oil, in the preparation of the alkyd resin. If so desired, mixtures of two or more of such monocarboxylic acids or triglycerides may be employed.

Optionally, isocyanates may also be used as building blocks for the oxidatively drying polyunsaturated condensation product. Suitable isocyanates are for example diisocyanates, such as 1,6-hexane diisocyanate, isophorone diisocyanate, toluene diisocyanate, diphenyl diisocyanate, and dicyclohexylmethane diisocyanate. Triisocyanates can also be used.

The unsaturated groups in the oxidatively drying polyunsaturated condensation product are preferably introduced by the fatty acids, but may, alternatively or additionally, be introduced by one or more of the polyols, carboxylic acids or anhydrides or other building blocks used, such as fatty mono-alcohols.

The oxidatively drying polyunsaturated condensation product has pendant groups in an amount of more than 20%, preferably more than 50%, by weight of the condensation product. An amount of more than 65% is even more preferred.

A specific example of a suitable alkyd is the condensation product of soya oil, phthalic anhydride, and pentaerythritol.

The alkyd resins can be obtained by direct esterification of the constituent components, with the option of a portion of these components having been converted already into ester diols or polyester diols. Alternatively, the unsaturated fatty acids can be added in the form of a drying oil, such as sunflower oil, linseed oil, tuna fish oil, dehydrated castor oil, coconut oil, and dehydrated coconut oil. Transesterification with the polyols and, optionally, other building blocks will then give the final alkyd resin. This transesterification generally takes place at a temperature in the range of 115 to 250° C., optionally with solvents such as toluene and/or xylene also present. The reaction generally is carried out in the presence of a catalytic amount of a transesterification catalyst. Examples of transesterification catalysts suitable for use include acids such as p-toluene sulphonic acid, a basic compound such as an amine, or compounds such as calcium-oxide, zinc oxide, tetraisopropyl orthotitanate, dibutyl tin oxide, and triphenyl benzyl phosphonium chloride.

Optionally, the oxidatively drying binder can be used in combination with other resins, for example acrylic resins or polyurethanes. Preferably, the coating composition comprises at least 20 wt. % of oxidatively drying binder, more preferably more than 60% by weight of total binder.

The average number molecular weight Mw of the binder will generally be above 150. Preferably, it will be higher than 1,000. For reasons of viscosity, the average number molecular weight will generally be below 120,000, preferably below 80,000.

The compound according to formula I can first be reacted with a metal ion, to form a metal complex which is subsequently added as a drier to the coating composition.

Alternatively, the compound according to formula I can be added separately, before, during or after the addition of a metal. In such case, complexing takes place in situ. The metal can for example be added in the form of a salt, e.g. halide salts, nitrates, or salts of organic acids such as octoates, hexanoates or naphthanates.

Optionally, a drying accelerator is used. A preferred example of such an accelerator is 2,2′-bipiridyl.

The invention is further described and illustrated by the following examples. In these examples the compositions listed below are available as indicated.

| | |
|---|---|
| Kronos ® 2310 | titanium dioxide white pigment, available from |
| | Kronos; |
| Mn 12 Cem-All ® LC | siccative comprising 12 wt.% |
| | manganese, commercially available from OMG; |
| Nuodex ® Ca 5 | siccative comprising 5 wt.% calcium, available |
| | from Condea Servo BV, Delden, the Netherlands; |
| Setal ® 270 | a conventional alkyd resin based on soya oil, |
| | pentaerythritol, and phthalic anhydride, having a |
| | solids content of about 70% in white spirit and |
| | having unsaturated pendant groups in an amount |
| | of about 59% by weight of the condensation |
| | product. Setal ® 270 is commercially available |
| | from Akzo Nobel Resins, Bergen op Zoom, |
| | the Netherlands; |
| Shellsol ® D40 | aromate-free organic solvent, available from |
| | Shell; |
| Zr 18 Hex-Cem ® | siccative comprising 18 wt.% zirconium, |
| | commercially available from 0MG. |

The drying time was measured as follows. The coating composition was applied on a glass plate with a draw bar (90 μm applicator). Curing took place at 10° C. and 80% relative humidity in a climatized room under TL-055 light. Drying was tested by means of a BK Drying Recorder. The results obtained in this fashion are classified as follows:

Phase 1: the line traced by the pin closes up again. The end of phase 1 is referred to as the “open time”.

Phase 2: the pin traces a scratchy line. The end of phase 2 is referred to as the “dust-free time”.

Phase 3: the pin traces a straight line in the paint which does not close up again. The end of phase 3 is referred to as the “tack-free time”.

### COMPARATIVE EXAMPLE A

The condensation reaction of 2 mol. equivalent salicyl aldehyde with 1 mol. equivalent 1,2-cyclohexylene diamine resulted in N,N′-bis(salicylidene) cyclohexylene diamine. This condensation product was added to Shellsole® D40 at a temperature of 23° C. The solubility of the ligand was less than 10 g/l.

### COMPARATIVE EXAMPLE B

Comparative Example A was repeated using 2-hydroxy 5-methyl benzaldehyde instead of salicyl aldehyde. Again, the resulting ligand was added to Shellsol® D40 at a temperature of 23° C. The solubilty of the ligand was less than 10 g/l.

### EXAMPLE 1

Comparative Example A was repeated using 2-hydroxy 3,5-di tert. butyl benzaldehyde instead of salicyl aldehyde. Obtained was a ligand according to formula I having two tert. butyl substitutions on the two aromatic groups A1 and A2. The solubility in Shellsol® D40 at a temperature of 23° C. was higher than 20 g/l.

### EXAMPLE 2

Comparative Example A was repeated again, now using 2-hydroxy 5-dodecyl benzaldehyde instead of salicyl aldehyde. Obtained was a ligand according to formula I having a dodecyl substitution on the two aromatic groups A1 and A2. The solubility in Shellsol® D40 at a temperature of 23° C. was higher than 100 g/l.

### COMPARATIVE EXAMPLE C

An opaque composition was prepared comprising Setal® 270 as a binder, Kronos® 2310 as a pigment, and Shellsol® D40 as a solvent. The pigment volume concentration was 15% and the total solids content was about 68% by weight of the complete formulation. In the composition, 0.5 parts by weight of Mn 12 Cem-All® LC (relative to 100 parts by weight of the solid binder) was present as a siccative in combination with 4.5 parts by weight of Nuodex® Ca and 5.2 parts by weight of Zr 18 Hex-Cem®. The composition was applied on a glass substrate and the drying time was measured. The end of phase 1 occurred after 1 hour, the end of phase 2 after 14 hours, and the end of phase 3 after 18 hours.

### EXAMPLE 3

The ligand as prepared in Example 2 was added to a composition as prepared in Comparative Example C. The composition was applied on a glass substrate and the drying time was measured. The end of phase 1 occurred after 0.8 hours, the end of phase 2 after 4.6 hours, and the end of phase 3 after 6.2 hours.

1. A coating composition comprising an oxidatively drying coating binder and a chelating compound comprising at least one group according to the following formula I: 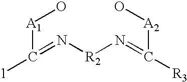
forming a complex with a metal ion, A1 and A2 both being an aromatic residue, R1 and R3 being covalently bonded groups, and R2 being a divalent organic radical, wherein at least one solubilizing group is covalently bonded to the chelating compound.

2. The coating composition according to claim 1, wherein the solubilizing group is a non-polar group.

3. The coating composition according to claim 2, wherein the non-polar solubilizing group is an aliphatic group having at least four carbon atoms.

4. The coating composition according to claim 1, wherein the solubilizing group is covalently bonded to A1 and/or A2.

5. The coating composition according to claim 1, wherein the metal ion is a divalent ion of a metal of manganese, cobalt, copper, lead, zirconium, iron, lanthanium, cerium, vanadium, or calcium.

6. The coating composition according to claim 1, wherein the metal ion is a trivalent ion of a metal of manganese, cobalt, lead, zirconium, iron, lanthanium, cerium, or vanadium, combined with a monovalent counterion.

7. The coating composition according to claim 1, wherein the solubilizing group is, in itself, in accordance with formula I.

8. The coating composition according to claim 7, wherein the chelating compound is a polymer comprising at least two groups according to formula I.

9. The coating composition according to claim 1, wherein the binder is an alkyd binder.

10. The coating composition according to claim 1, wherein the composition is solvent borne, preferably comprising a non-aromatic solvent.

11. The coating composition according to claim 10, wherein the solvent borne composition comprises a non-aromatic solvent.

12. An oxidatively drying coating composition comprising the coating composition of claim 1.

13. The oxidatively drying coating composition of claim 13, wherein the oxidatively drying coating composition is an alkyd paint.

14. The oxidatively drying coating composition according to claim 13, wherein the metal ion is a trivalent metal ion and the compound further comprises a monovalent counterion.

15. A coating composition prepared by combining an oxidatively drying binder, a polyvalent metal ion and a compound according to formula I: 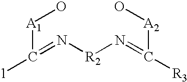
A1 and A2 both being an aromatic residue, R1 and R3 being covalently bonded groups, and R2 being a divalent organic radical, wherein at least one solubilizing group is covalently bonded to the chelating compound.

16. The method according to claim 15, wherein the metal ion is added in the form of a salt of a trivalent metal ion and a monovalent counterion.

17. The method according to claim 16, wherein the monovalent counterion is a halogen, octoate, or benzoxy ion.
